(19) United States
(12) Patent Application Publication
(10) Pub. No.: US 2026/0303872 A1
(43) Pub. Date: Oct. 1, 2026

(54) DECODED ATLAS HASH SEI FOR DYNAMIC MESH COMPRESSION STANDARD

(71) Applicants: SONY GROUP CORPORATION, Tokyo (JP); SONY CORPORATION OF AMERICA, New York, NY (US)

(72) Inventors: Danillo Graziosi, San Jose, CA (US); Ali Tabatabai, San Jose, CA (US)

(73) Assignees: SONY GROUP CORPORATION, Tokyo (JP); SONY CORPORATION OF AMERICA, New York, NY (US)

(21) Appl. No.: 19/556,209

(22) Filed: Mar. 4, 2026

Related U.S. Application Data
(60) Provisional application No. 63/781,217, filed on Mar. 31, 2025.

(51) Int. Cl. H04N 19/70; H04N 19/597

(52) U.S. Cl. CPC H04N 19/70; H04N 19/597

(57) ABSTRACT

The Decoded Atlas Information Hash SEI in V3C is an SEI message that produces a hash for the decoded atlas bitstream. In its conception, it has application parts that apply currently to V-PCC bitstreams only. This disclosure describes a modification of the V-DMC specification to reuse the SEI message but create hash values according to decoded syntax elements from the VDMC bitstream. The new hash derivation process can also be used for conformance purposes, like what is done in V-PCC.

### CROSS-REFERENCE TO RELATED APPLICATIONS

This application claims priority to, and the benefit of, U.S. provisional patent application Ser. No. 63/781,217 filed on Mar. 31, 2025, incorporated herein by reference in its entirety.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to Visual Volumetric Video-based Coding (V3C) syntax standards, and more particularly to extending existing decoded atlas hash Supplemental Enhancement Information (SEI) for Video-based Dynamic Mesh Coding (VDMC).

### 2. Background Discussion

Current Visual Volumetric Video-based Coding (V3C) syntax standards do not fully support efficient Video-based Dynamic Mesh Coding (VDMC).

Accordingly, a need exists for enhanced syntax and coding to support VDMC. The present disclosure fulfills that need and provides additional benefits over existing systems.

### BRIEF SUMMARY

This invention discloses mechanisms to extend the Visual Volumetric Video-based Coding (V3C) standard syntax for transmission of dynamic meshes by proposing a modification of the existing decoded atlas hash SEI to use syntax elements and variables defined in the Video-based Dynamic Mesh Coding (VDMC) specification.

The V3C specification, on which the VDMC specification is based, contains an SEI message that generates hashes for the decoded atlas frame. The Decoded Atlas Hash SEI message can also be used for conformance test since the hash values can be generated at encoder and decoder sides and be used for bitstream mismatch testing. Nevertheless, the SEI message defined in V3C contains elements that are used only by the Video-based Point Cloud Compression (V-PCC) specification, that is, in the case of a point cloud application.

For the VDMC specification, which defines decoding process for dynamic meshes, the variables used are either not present in the bitstream or are not used by the reconstruction process. We then propose to create new byte strings based on variables and syntax elements used by the extension mechanism of the VDMC specification, that is, present in ASPS VDMC extension, AFPS VDMC extension, and also the newly defined mesh patches.

The invention discloses the extension of the V3C syntax with new syntax elements to enable efficient encoding of dynamic meshes, in particular the modification of a V3C level SEI message to calculate the hash using new syntax elements from the VDMC specification.

This invention discloses syntax elements to encode dynamic meshes using the V3C standard. The main feature of this invention is a new method to obtain the syntax elements of an existing SEI message present in the V3C specification, using new syntax elements that belong to the VDMC specification.

The new VDMC standard for compression of dynamic meshes is going to be a future extension of the V3C standard, the current international standard for video-based volumetric coding. The new syntax disclosed here addresses some key new technologies for efficient encoding, such as the usage of texture mapping and displacement images, it also integrates this new technology while preserving the existing V3C syntax.

The disclosed syntax can be used to transmit parameters for the basemesh bitstream, and allows better integration with current V3C syntax elements currently being used for other data type, such as point cloud encoding. Additionally, it uses the concept of sub-patches to transmit texture parametrization information for the basemesh, and allows a flexible data arrangement in 2D and in 3D, with different mappings for the texture location in 2D and for the face mapping in 3D.

The concept of Decoded Atlas HASH SEI already exists in the V3C specification, but the creation of HASH values considering syntax elements and variables form the V-DMC specification has not been addressed before.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1A through FIG. 1C is the SEI format defined in V3C (from V3C 4^{th} edition.

FIG. 2 is a flow diagram of a hash calculation, whereby the hash value is introduced in the bitstream at the encoder side.

FIG. 3 is a flow diagram of another hash calculation performed on the decoder side, whereby the local hash value is compared to the one carried in the bitstream to ensure the integrity of the bitstream.

FIG. 4A through FIG. 4C are data structure diagrams of hash calculations on a V-PCC bitstream.

FIG. 5A through FIG. 5C are data structure diagrams of hash calculations for a V-DMC bitstream having an atlas bitstream and Hash SEI according to at least one embodiment of the present disclosure.

FIG. 6 is a flow diagram of determining a hash for a V-DMC atlas bitstream using subdivision, quantization, lifting and other sequence level coding tools and parameters, according to at least one embodiment of the present disclosure.

FIG. 7 is a flow diagram of determining a hash for a V-DMC atlas bitstream using subdivision, quantization, lifting and other frame level coding tools and parameters, according to at least one embodiment of the present disclosure.

FIG. 8 is a flow diagram of determining a hash for a V-DMC atlas bitstream using subdivision, quantization, lifting and other meshpatch-level coding tools and parameters, according to at least one embodiment of the present disclosure.

### DETAILED DESCRIPTION

### 1. INTRODUCTION

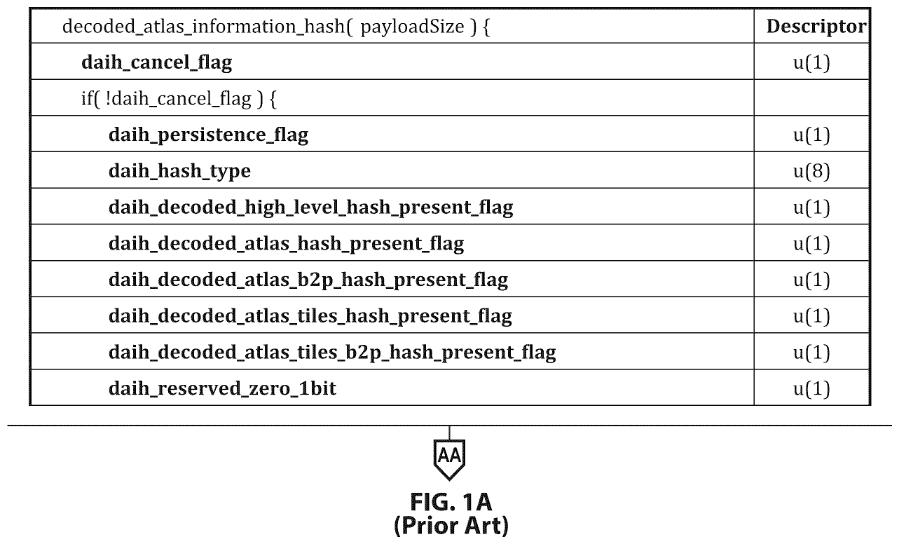

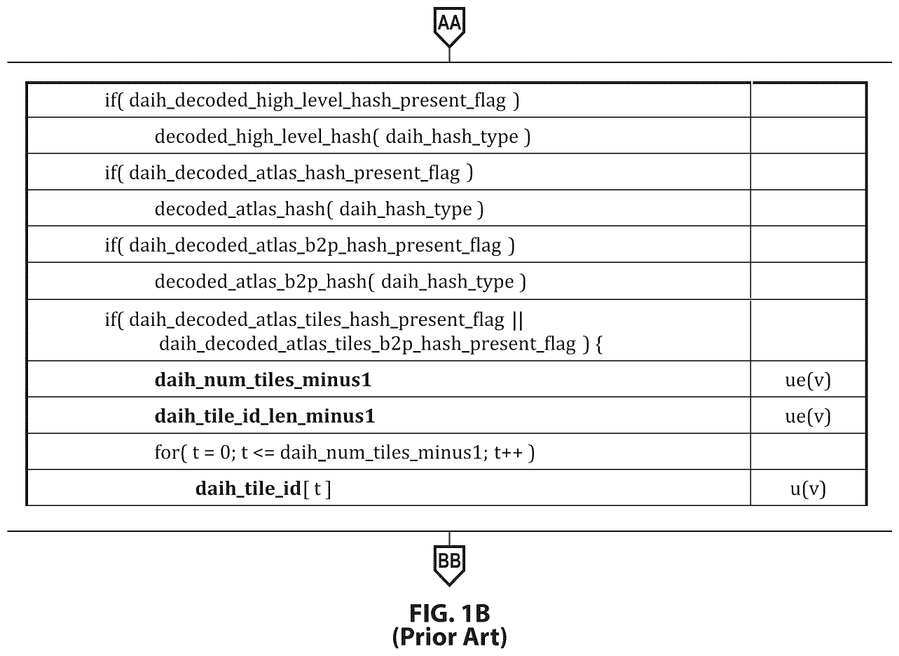

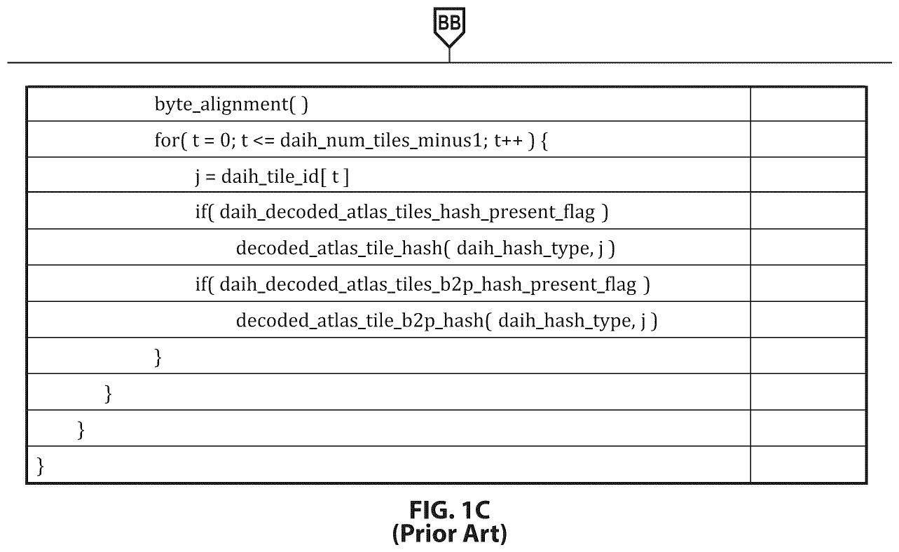

1.1. FIG. 1A through FIG. 1C depict the SEI format defined in V3C (from V3C 4^{th} edition, subclause F.2.12.1). It contains the sequence of syntax elements to be added to the bitstream, describing the hash values obtained from the elements of the coded volumetric sequence. The table format facilitates the understanding on the order of how the elements are introduced in the bitstream.

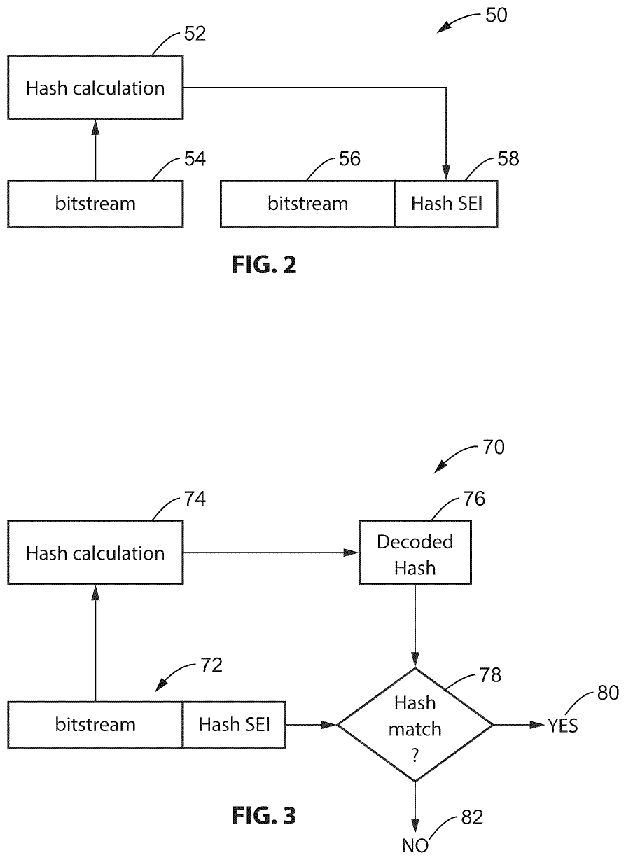

FIG. 2 illustrates 50 a current form of hash calculation showing a bitstream 54 used in the hash calculation 52 with output being the bitstream 56 with its Hash SEI 58. This operation is performed on the encoder side, to add the hash value to the bitstream to be transmitted.

FIG. 3 illustrates 70 a current form of hash calculation 74 showing a received bitstream 72 with attached hash value, whereby 76 the decoded hash is further 78 compared to the hash transmitted in 72 of the received bitstream. This operation is performed at the decoder side, to check if the transmitted hash value is the same (Yes 80) as the locally calculated hash value or if it is different (No 82) than the locally calculated hash value.

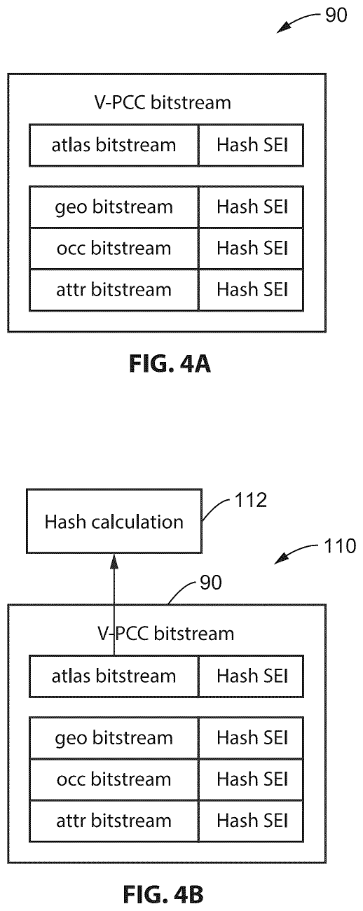

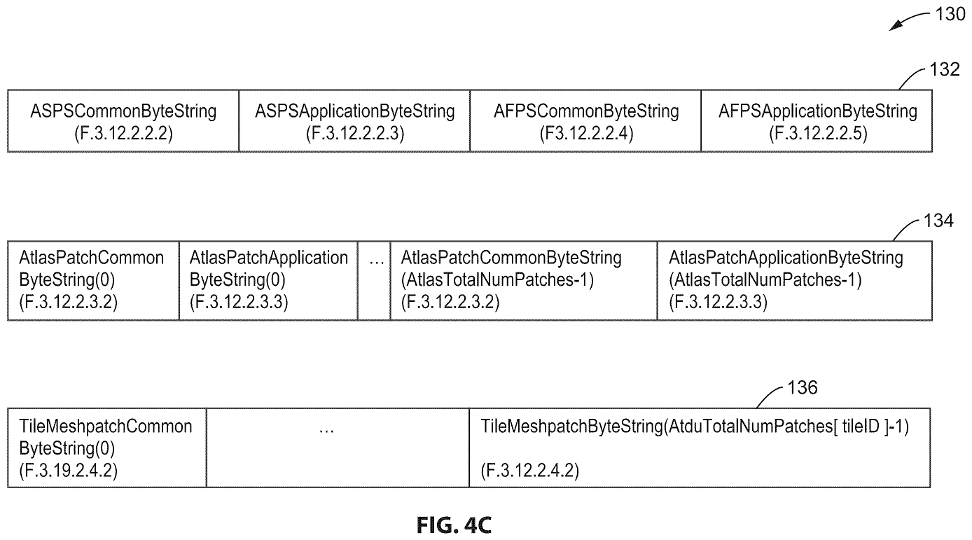

FIG. 4A through FIG. 4C illustrate hash calculations on a V-PCC bitstream.

In FIG. 4A is depicted 90 a V-PCC bitstream having an atlas bitstream and Hash SEI, a geo bitstream and Hash SEI, an occupancy bitstream and Hash SEI, and a attribute bitstream and Hash SEI.

In FIG. 4B is depicted 110 a hash calculation 112 performed on V-PCC bitstreams 90.

The block to patch, being the structure indicating to which patches the blocks in the video frame belong to, perform a hash using the patch location, and since we do not have patches in VDMC, only meshpatches, the preset flags for those two syntax structures can be enforced to always be zero.

In FIG. 4C 130 depicts existing syntax structures.

A decode_high_level_hash syntax structure 132 is a hash/md5sum/checksum syntax element of a string of bytes created using the subclause F.3.12.2.2, having fields ASPSCommonByte String (F.3.12.2.2.2).

A decode_atlas_hash syntax structure 134 is a hash/md5sum/checksum syntax element of a string of bytes created using subclause F.3.12.2.3, having fields AtlasPatchCommonByteString(0) (F.2.12.2.3.2).

A decode_atlas_tile_hash syntax structure 136 is a hash/md5sum/checksum syntax element of a string of bytes created using subclause F.3.12.2.4, having fields TileMeshPatchCommonByteString(0) (F.3.19.2.4.2).

### 2.0. EMBODIMENTS OF THE PRESENT DISCLOSURE

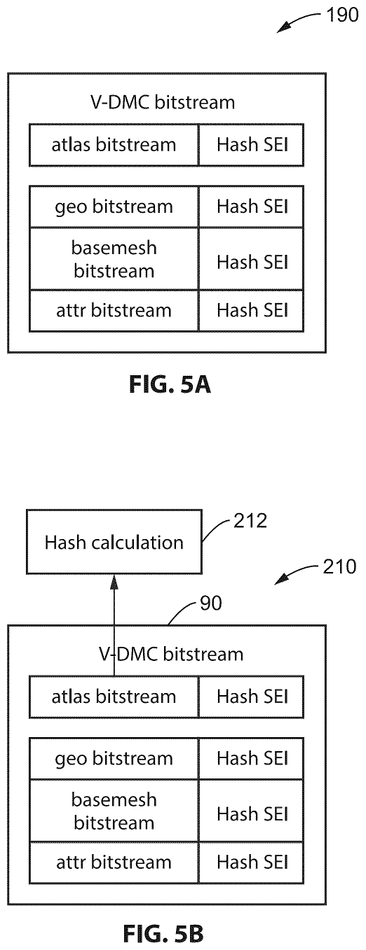

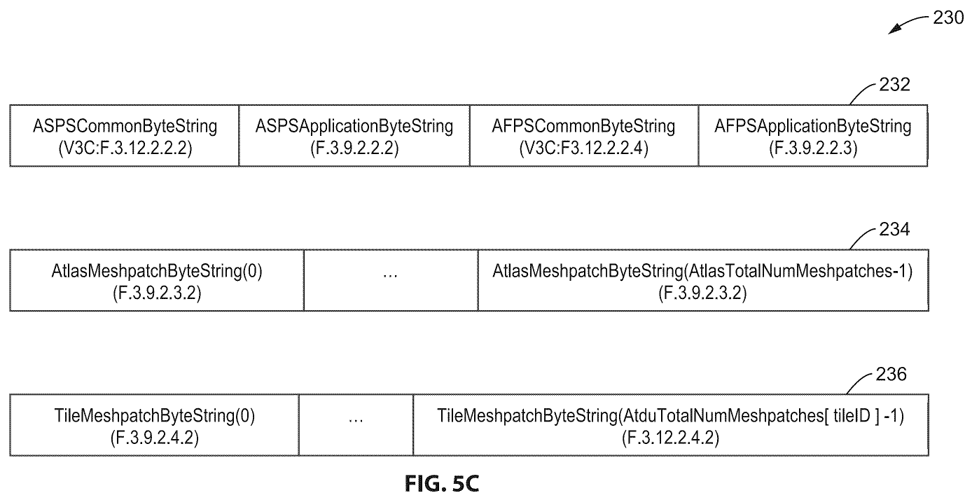

FIG. 5A through FIG. 5C illustrates a V-DMC bitstream 190 with hash calculations.

In FIG. 5A is illustrated 190 a V-DMC bitstream having an atlas bitstream and Hash SEI, a geo bitstream and Hash SEI, a basemesh bitstream and Hash SEI, and a attr bitstream and Hash SEI.

In FIG. 5B is illustrated 210 a hash calculation 212 performed on these V-DMC bitstreams 190.

In FIG. 5C is illustrated 230 syntax structures according to an embodiment of the present disclosure.

A decode_high_level_hash 232 is a hash/md5sum/checksum syntax element of a string of bytes created using the subclause F.3.12.2.2, having fields ASPSCommonByteString (V3C:F.3.12.2.2.2).

A structure decode_atlas_hash 234 is a hash/md5sum/checksum syntax element of a string of bytes created using subclause F.3.12.2.3, having fields AtlasMeshpatchByteString(0) (F.3.9.2.3.2), through to AtlasMeshpatchByteString(AtlastTotalNumMeshpatches−1) (F.3.9.2.3.2).

A decode_atlas_tile_hash 236 is a hash/md5sum/checksum syntax element of a string of bytes created using subclause F.3.12.2.4, having fields TileMeshpatchByteString(0) (F.3.9.2.4.2) through to TileMeshpatchByteString(AtduTotalNumMeshpatches[tile ID] −1) (F.3.12.2.4.2)

FIG. 6 illustrates 250 a hash calculation on a V-DMC atlas bitstream, showing that the bitstream is processed using subdivision, quantization, lifting and other sequence-level coding tools and parameters. This corresponds to code section 3.1. below as ASPS Application Byte String.

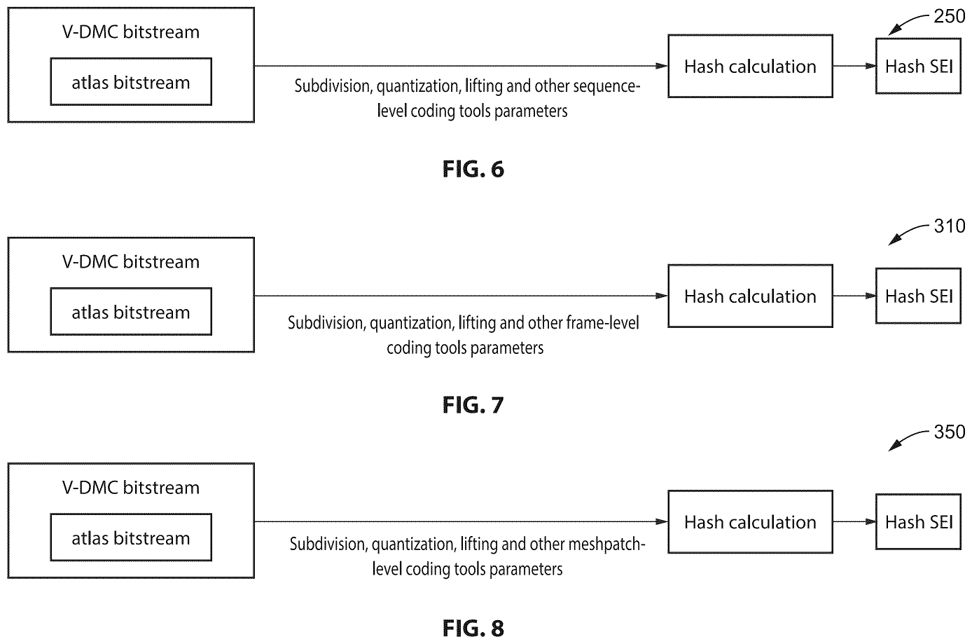

FIG. 7 illustrates 310 a hash calculation on a V-DMC atlas bitstream, showing that the bitstream is processed using subdivision, quantization, lifting and other frame-level coding tools and parameters. This corresponds to code section 3.2. below as AFPS Application Byte String.

FIG. 8 illustrates 350 a hash calculation on a V-DMC atlas bitstream, showing that the bitstream is processed using subdivision, quantization, lifting and other meshpatch-level coding tools and parameters. This corresponds to code section 3.4 and/or 3.5 below as Atlas Meshpatch Byte String and/or Tile Meshpatch Byte String. The difference between 3.4. and 3.5. is the order that the meshpatches are processed (3.4. processes all meshpatches per frame, while 3.5. divides the frames into tiles and processes all meshpatches per tile).

### 3. CODE SECTION

### ASPS Application Byte String

The ASPS Application contains variables from the VDMC specification that are defined in the ASPS extension for VDMC. The string is generated in the following way.

### 3.1. ASPS Application Byte String

The code here has the following sections Subdivision, Quantization, Transform, Attribute Frame, and OrthoAtlas.

```
    ASPSApplicationByteString( stringByte, posByte ) {
    // ------ SUBDIVISION ------
stringByte[ posByte++ ] = AspsSubdivisionCount & 0xFF for( i=0; i <
AspsSubdivisionCount ; i++)
stringByte[ posByte++ ] = AspsSSUubBdiDviIsViIoSnMIOetNhod[ i ] & 0xFF
stringByte[ posByte++ ] = AspsSubdivisionMinEdgeLength & 0xFF
stringByte[ posByte++ ] = ( AspsSubdivisionMinEdgeLength >> 8 ) & 0xFF
stringByte[ posByte++ ] = asve_1d_displacement_flag & 0xFF
stringByte[ posByte++ ] = asve_interpolate_subdivided_normals_flag & 0xFF
stringByte[ posByte++ ] = asve_quantization_parameters_present_flag &
0xFF
    // ------ QUANTIZATION ------
if( asve_quantization_parameters_present_flag ) {
stringByte[ posByte++ ] = asve_inverse_quantization_offset_present_flag &
0xFF
QuantizationParametersByteString( stringByte, posByte , 0,
AspsSubdivisionCount )
}
    // ------ TRANSFORM ------
if( AspsSubdivisionCount != 0 )
stringByte[ posByte++ ] = AspsTransformMethod & 0xFF stringByte[ posByte+
+ ] = AspsLiftingOffsetPresentFlag & 0xFF
stringByte[ posByte++ ] = AspsDireTcRtiAonNalSLFifOtiRngMPresentFlag &
0xFF
if( AspsTransformMethod == LINEAR_LIFTING && AspsSubdivisionCount !=
0 )
LiftingTransformParametersByteString( stringByte, posByte , 0,
AspsSubdivisionCount )
    // ----- ATTRIBUTE FRAME ------
stringByte[ posByte++ ] = asve_attribute_information_present_flag & 0xFF
if(asve_attribute_information_present_flag ) {
    stringByte[ posByte++ ] = asve_attribute_frame_size_count & 0xFF
    for( i = 0; i < AspsAttributeNominalFrameSizeCount ; i++) {
        stringByte[ posByte++ ] = asve_attribute_frame_width[ i ] & 0xFF
        stringByte[ posByte++ ] =
          (asve_attribute_frame_width[ i ] >> 8) & 0xFF
      stringByte[ posByte++ ] =
          (asve_attribute_frame_width[ i ] >> 16) & 0xFF
      stringByte[ posByte++ ] =
          (asve_attribute_frame_width[ i ] >> 24) & 0xFF
      stringByte[ posByte++ ] =
          asve_attribute_frame_height[ i ] & 0xFF
      stringByte[ posByte++ ] =
          (asve_attribute_frame_height[ i ] >> 8) & 0xFF
      stringByte[ posByte++ ] =
          (asve_attribute_frame_height[ i ] >> 16) & 0xFF
      stringByte[ posByte++ ] =
          (asve_attribute_frame_height[ i] >> 24) & 0xFF
      stringByte[ posByte++ ] =
          asve_attribute_subtexture_enabled_flag[ i ] & 0xFF
      }
}
    // ------ ORTHOATLAS ------
stringByte[ posByte++ ] = AspsDisplacementIdPresentFlag & 0xFF
stringByte[ posByte++ ] = AspsLodPatchesEnableFlag & 0xFF
stringByte[ posByte++ ] = AspsPackingMethod & 0xFF
stringByte[ posByte++ ] = asve_projection_texcoord_enable_flag & 0xFF
if( asve_projection_texcoord_enable_flag ) {
    stringByte[ posByte++ ] =
  asve_projection_texcoord_mapping_attribute_index_present_flag & 0xFF
        if( asve_projection_texcoord_mapping_attribute_index_present_flag )
        stringByte[ posByte++ ] =
  asve_projection_texcoord_mapping_attribute_index & 0xFF
        stringByte[ posByte++ ] =
  asve_projection_texcoord_output_bit_depth_minus1 & 0xFF
        stringByte[ posByte++ ] =
AspsProjectionTexcoordBboxBiasEnableFlag & 0xFF
        stringByte[ posByte++ ] = AspsTexcoordProjectionUpscaleFactor &
0xFF
        stringByte[ posByte++ ] = ( AspsTexcoordProjectionUpscaleFactor
>> 8 ) & 0xFF
        stringByte[ posByte++ ] = ( AspsTexcoordProjectionUpscaleFactor
>> 16 ) & 0xFF
        stringByte[ posByte++ ] = ( AspsTexcoordProjectionUpscaleFactor
>> 24 ) & 0xFF
        stringByte[ posByte++ ] = ( AspsTexcoordProjectionUpscaleFactor
>> 32 ) & 0xFF
        stringByte[ posByte++ ] =
AspsTexcoordProjectionDownscaleFactor & 0xFF
        stringByte[ posByte++ ] =
asve_projection_raw_textcoord_present_flag &0xFF
        if( asve_projection_raw_textcoord_present_flag )
            stringByte[ posByte++ ] =
  asve_projection_raw_textcoord_bitdepth_minus1 & 0xFF
        }
// ----------
    return posbyte
}
```

### 3.2. AFPS Application Byte String

The AFPS Application contains variables from the VDMC specification that are defined in the AFPS extension for VDMC. The string is generated in the following way:

```
        AFPSApplicationByteString( stringByte, posByte ) {
        // ------ SUBDIVISION ------
stringByte[ posByte++ ] = AfpsSubdivisionCount & 0xFF
for( i=0; i < AfpsSubdivisionCount ; i++ )
    stringByte[ posByte++ ] = AfpsSubdivisionMethod[ i ] & 0xFF
    stringByte[ posByte++ ] = AfpsSubdivisionMinEdgeLength & 0xFF
    stringByte[ posByte++ ] = ( AfpsSubdivisionMinEdgeLength >> 8 ) & 0xFF
        // ------ QUANTIZATION -------
if( afve_quantization_parameters_present_flag )
        QuantizationParametersByteString( stringByte, posByte, 1,
AfpsSubdivisionCount )
        // ------ TRANSFORM -------
        stringByte[ posByte++ ] = AfpsTransformMethod & 0xFF
        if( afve_transform_method == LINEAR_LIFTING &&
afve_transform_parameters_present_flag )
        LiftingTransformParametersByteString( stringByte, posByte, 1,
AfpsSubdivisionCount )
        // ----- ATTRIBUTE TILE FRAME iNFORMATION -------
if( asve_attribute_information_present_flag ) {
          stringByte[ posByte++ ] =
afve_consistent_tiling_across_attribute_video_flag & 0xFF
    if( afve_consistent_tiling_across_attribute_video_flag ) {
        stringByte[ posByte++ ] = afve_reference_attribute_idx & 0xFF
        AtlasAttributeTileInformationByteString( stringByte, posByte,
afve_reference_attribute_idx )
      } else {
          for( i= 0; i < AspsAttributeNominalFrameSizeCount; i++ )
              AtlasAttributeTileInformationByteString( stringByte, posByte, i )
            }
}
        // ------ MESH INFORMATION -------
AtlasFrameMeshInformationByteString( stringByte, posByte )
        // ------ ORTHO ATLAS-------
if( asve_projection_texcoord_enable_flag ) {
    for( i = 0;i < NumSubMeshes; i++ ) {
    stringByte[posByte++] = AfpsTexcoordProjectionFlag[ i ]&0xFF
    if( AfpsTexcoordProjectionFlag[ i ]) {
        stringByte[ posByte++ ] =
AfpsTexcoordProjectionWidthNormalization[ i ] & 0xFF
        stringByte[ posByte++ ] =
            ( AfpsTexcoordProjectionWidthNormalization[ i ] >> 8 ) & 0xFF
        stringByte[ posByte++ ] =
            ( AfpsTexcoordProjectionWidthNormalization[ i ] >> 16 ) & 0xFF
        stringByte[ posByte++ ] =
            ( AfpsTexcoordProjectionWidthNormalization[ i ] >> 24 ) & 0xFF
        stringByte[ posByte++ ] =
              AfpsTexcoordProjectionHeightNormalization[ i ] & 0xFF
        stringByte[ posByte++ ] =
              ( AfpsTexcoordProjectionHeightNormalization[ i ] >> 8 ) & 0xFF
        stringByte[ posByte++ ] =
              ( AfpsTexcoordProjectionHeightNormalization[ i ] >> 16 ) & 0xFF
        stringByte[ posByte++ ] =
              ( AfpsTexcoordProjectionHeightNormalization[ i ] >> 24 ) & 0xFF
        stringByte[ posByte++ ] = AfpsTexcoordProjectionGutter[ i ] & 0xFF
        stringByte[ posByte++ ] =
              ( AfpsTexcoordProjectionGutter[ i ] >> 8 ) & 0xFF
        stringByte[ posByte++ ] =
              ( AfpsTexcoordProjectionGutter[ i ] >> 16 ) & 0xFF
        stringByte[ posByte++ ] =
              ( AfpsTexcoordProjectionGutter[ i ] >> 24 ) & 0xFF
            }
        }
  }
        //----------
        return posbyte
}
```

### 3.3. Auxiliary Byte String Functions

The ASPS and AFPS Application uses the following functions:

```
        // ------ QUANTIZATION ------
QuantizationParametersByteString( stringByte , posByte , qpIndex) {
  for( k = 0 ; k < AspsDispComponents; k++ ) {
      for( i =0 ; i < subdivisionCount + 1; i++ )
        stringByte[ posByte++ ] =
          QuantizationParameter[ qpIndex ][ i ][ k ] & 0xFF
        stringByte[ posByte++ ] =
          vqp_log2_lod_inverse_scale[ qpIndex ][ k ] & 0xFF
  }
  stringByte[ posByte++ ] =
        vqp_direct_quantization_enabled_flag[ qpIndex ] & 0xFF
  if( vqp_direct_quantization_enabled_flag[ qpIndex ] ) {
        stringByte[ posByte++ ] = vqp_bitdepth_offset[ qpIndex ] & 0xFF
        stringByte[posByte++] = ( vqp_bitdepth_offset[qpIndex] >> 8 ) &0xFF
  }
  return posByte
}
        // ------LIFTING TRANSFORM ------
LiftingTransformByteString( stringByte, posByte ,ltpIndex) {
  stringByte[ posByte++ ] = vltp_valence_update_flag[ ltpIndex ] & 0xFF
  for( i = 0 ; i < subdivisionCount ; i++ ) {
        stringByte[ posByte++ ] = UpdateWeight[ ltpIndex ][ i ] & 0xFF
        stringByte[ posByte++ ] = ( UpdateWeight[ ltpIndex ][ i ] >> 8 ) & 0xFF
        stringByte[ posByte++ ] = ( UpdateWeight[ ltpIndex ][ i ] >> 16 ) & 0xFF
        stringByte[ posByte++ ] = ( UpdateWeight[ ltpIndex ][ i ] >> 24 ) & 0xFF
        stringByte[ posByte++ ] = PredictionWeight[ ltpIndex ][ i ] & 0xFF
        stringByte[ posByte++ ] =
          (PredictionWeight[ ltpIndex ][ i ] >> 8 ) & 0xFF
        stringByte[ posByte++ ] =
          ( PredictionWeight[ ltpIndex ][ i ] >> 16 ) & 0xFF
        stringByte[ posByte++ ] =
          ( PredictionWeight[ ltpIndex ][ i ] >> 24 ) & 0xFF
  }
  return posByte
}
        // ------ ATLAS ATTRIBUTE INFORMATION -------
AtlasAttributeTileInformationByteString( stringByte, posByte , attrIdx ) {
  stringByte[ posByte++ ] =
          aftai_num_tiles_in_atlas_frame_minus1[ attrIdx ] & 0xFF
    for( i = 0; i < aftai_num_tiles_in_atlas_frame_minus1[ attrIdx ] + 1; i++ ) {
        stringByte[ posByte++ ] = aftai_tile_id[ attrIdx ][ i ] & 0xFF
        stringByte[ posByte++ ] = ( aftai_tile_id[ attrIdx ][ i ] >> 8 )& 0xFF
    }
    return posByte
}
        // ------MESH INFORMATION -------
MeshInformationByteString( stringByte, posByte ){
    stringByte[ posByte++ ] = NumSubMeshes & 0xFF
    for( i = 0; i < NumSubMeshes; i++ ) {
        stringByte[ posByte++ ] = afmi_submesh_id[ i ] & 0xFF
        stringByte[ posByte++ ] = ( afmi_submesh_id[ i ] >> 8 ) & 0xFF
    }
    return posByte
}
```

### 3.4. Atlas Meshpatch Byte String

The Atlas meshpatch byte string is formed from variables that are defined in the tile to atlas frame conversion subclause (9.2.9). The string is generated in the following way:

```
      // -------
      AtlasMeshpatchByteString( stringByte, posByte, p ) {
  stringByte[ posByte++ ] = AtlasFrameSubmeshID[ p ] & 0xFF
  stringByte[ posByte++ ] = ( AtlasFrameSubmeshID[ p ] >> 8 ) & 0xFF
if( AtlasFramePatchType[ p ] == 0 ){
    if( AspsDisplacementIdPresentFlag )
      stringByte[ posByte++ ] = AtlasFrameDisplID[ p ] & 0xFF
      stringByte[ posByte++ ] = ( AtlasFrameDisplID[ p ] >> 8 ) & 0xFF
    else {
      // ------ GEOMETRY FRAME INFORMATION -------
      stringByte[ posByte++ ] = AtlasFrame2dPosX[ p ] & 0xFF
      stringByte[ posByte++ ] = ( AtlasFrame2dPosX[ p ] >> 8 ) & 0xFF
      stringByte[ posByte++ ] = AtlasFrame2dPosY[ p ] & 0xFF
      stringByte[ posByte++ ] = ( AtlasFrame2dPosY[ p ] >> 8 ) & 0xFF
      stringByte[ posByte++ ] = AtlasFrame2dSizeX[ p ] & 0xFF
      stringByte[ posByte++ ] = ( AtlasFrame2dSizeX[ p ] >> 8 ) & 0xFF
      // --------
    }
    stringByte[ posByte++ ] = AtlasFrameLoDIdx[ p ] & 0xFF
    if( AtlasFrameLoDIdx[ p ] == 0 ) {
      // ------ SUBDIVISION -------
      stringByte[ posByte++ ] = AtlasFrameSubdivCount[ p ] & 0xFF
      for( i = 0; i < AtlasFrameSubdivCount[ p ] ; i++ ) {
        stringByte[ posByte++ ] = AtlasFrameSubdivMethod[ p ][ i ] & 0xFF
      }
      stringByte[ posByte++ ] =
          AtlasFrameSubdivMinEdgeLength[ p ] & 0xFF
      stringByte[ posByte++ ] =
          (AtlasFrameSubdivMinEdgeLength[ p ] >> 8 ) & 0xFF
      // ------- QUANTIZATION -------
      stringByte[ posByte++ ] = AtlasFrameVQPIQSkipFlag[ p ] & 0xFF
      if( !AtlasFrameVQPIQSkipFlag[ p ] ){
        stringByte[ posByte++ ] =
          AtlasFrameVQPLoDQuantizationFlag[ p ] & 0xFF
        stringByte[ posByte++ ] = AtlasFrameVQPBitDepthOffset[ p ] & 0xFF
        stringByte[ posByte++ ] =
          ( AtlasFrameVQPBitDepthOffset[ p ] >> 8 ) & 0xFF
        for( k = 0; k < AspsDispComponents; k++ ) {
          for( i = 0; i < AtlasFrameSubdivCount[ p ] + 1; i++ ) {
            stringByte[ posByte++ ] =
            AtlasFrameVQPQuantizationParameters[ p ][ i ][ k ] & 0xFF
          }
          stringByte[ posByte++ ] =
              AtlasFrameVQPLodInverseScale[ p ][ k ] & 0xFF
        }
        stringByte[ posByte++ ] =
          AtlasFrameVQPDirectQuantizationEnableFlag[ p ] & 0xFF
        stringByte[ posByte++ ] =
          AtlasFrameVQPInvQuantOffsetEnableFlag[ p ] & 0xFF
        if( AtlasFrameVQPInvQuantOffsetEnableFlag[ p ] ){
        for( i = 0; i < AtlasFrameSubdivCount[ p ] + 1; i++ ) {
          for( j = 0; j < AspsDispComponents; j++ ) {
            for( k = 0; k < 3; k++ ) {
              stringByte[ posByte++ ] =
          AtlasFrameVQPInvQuantOffsetSign[ p ][ i ][ j ][ k ] & 0xFF
              stringByte[ posByte++ ] =
          AtlasFrameVQPInvQuantOffsetValuePrec1[ p ][ i ][ j ][ k ] & 0xFF
              stringByte[ posByte++ ] =
          AtlasFrameVQPInvQuantOffsetValuePrec2[ p ][ i ][ j ][ k ] & 0xFF
            }
          }
          }
        }
      }
      // ------------
      stringByte[ posByte++ ] = AtlasFrameDispCoordSys[ p ] & 0xFF
      stringByte[ posByte++ ] = AtlasFrameTransformMethod[ p ] & 0xFF
      // -------- TRANSFORM --------
      if( AtlasFrameTransformMethod[ p ] == LINEAR_LIFTING ) {
        if( AspsLiftingOffsetPresentFlag == 1 ) { stringByte[ posByte++ ] =
            AtlasFrameDirectionalLiftingMeanNum[ p ] & 0xFF
          stringByte[ posByte++ ] =
            AtlasFrameDirectionalLiftingMeanDeno[ p ] & 0xFF
          stringByte[ posByte++ ] =
            AtlasFrameDirectionalLiftingStdNum[ p ] & 0xFF
          stringByte[ posByte++ ] =
            AtlasFrameDirectionalLiftingStdDeno[ p ] & 0xFF
        }
        stringByte[ posByte++ ] =
            AtlasFrameVLTPSkipUpdateFlag[ p ] & 0xFF
        stringByte[ posByte++ ] =
            AtlasFrameVLTPValenceUpdateFlag[ p ] & 0xFF
        for( i = 0; i < AtlasFrameSubdivCount[ p ]; i++ ) {
          stringByte[ posByte++ ] =
            AtlasFrameVLTPUpdateWeight[ p ][ i ] & 0xFF
          stringByte[ posByte++ ] =
            ( AtlasFrameVLTPUpdateWeight[ p ][ i ] >> 8 ) & 0xFF
          stringByte[ posByte++ ] =
            ( AtlasFrameVLTPUpdateWeight[ p ][ i ] >> 16 ) & 0xFF
          stringByte[ posByte++ ] =
            ( AtlasFrameVLTPUpdateWeight[ p ][ i ] >> 24 ) & 0xFF
          stringByte[ posByte++ ] =
            AtlasFrameVLTPPredictionWeight[ tileID ][ p ][ i ] & 0xFF
          stringByte[ posByte++ ] =
            (AtlasFrameVLTPPredictionWeight[ p ][ i ] >> 8 ) & 0xFF
          stringByte[ posByte++ ] =
            ( AtlasFrameVLTPPredictionWeight[ p ][ i ] >> 16 ) & 0xFF
          stringByte[ posByte++ ] =
            ( AtlasFrameVLTPPredictionWeight[ p ][ i ] >> 24 ) & 0xFF
        }
      }
    }
      // -------- VERTEX INFO COUNT --------
      vertexInfoCount = 1
      if( AspsDisplacementIdPresentFlag ||
          AspsLodPatchesEnableFlag == 0 )
          vertexInfoCount = AtlasFrameSubdivCount[ atlasPatchIdx ] + 1
      for( i=0; i < vertexInfoCount; i++){
        stringByte[ posByte++ ] = AtlasFrameBlockCount[ p ][ i ] & 0xFF
        stringByte[ posByte++ ] =
          (AtlasFrameBlockCount[ p ][ i ] >> 8 ) & 0xFF
        stringByte[ posByte++ ] =
          ( AtlasFrameBlockCount[ p ][ i ] >> 16 ) & 0xFF
        stringByte[ posByte++ ] =
          ( AtlasFrameBlockCount[ p ][ i ] >> 24 ) & 0xFF
        stringByte[ posByte++ ] = AtlasFrameLastPosInBlock[ p ][ i ] & 0xFF
        stringByte[ posByte++ ] =
          (AtlasFrameLastPosInBlock[ p ][ i ] >> 8 )& 0xFF
        stringByte[ posByte++ ] =
          (AtlasFrameLastPosInBlock[ p ][ i ] >> 16 )& 0xFF
        stringByte[ posByte++ ] =
          (AtlasFrameLastPosInBlock[ p ][ i ] >> 24 )& 0xFF
      }
      // -------- ORTHOATLAS --------
      smIdx = SubmeshIDToIndex[ AtlasSubmeshID[ atlasPatchIdx ]]
      if( AtlasFrameLoDIdx[p] == 0 && AfpsTexcoordProjectionFlag[ smIdx ])
        AtlasSubpatchByteString( stringByte, posByte, p )
//----------
      } else {
      // -------- ATTRIBUTE TILE FRAME INFORMATION --------
      stringByte[ posByte++ ] = AtlasFrameAttributes2dPosX[ p ] & 0xFF
      stringByte[ posByte++] = (AtlasFrameAttributes2dPosX[ p ] >> 8)&0xFF
      stringByte[ posByte++ ] = AtlasFrameAttributes2dPosY[ p ] & 0xFF
      stringByte[ posByte++] = (AtlasFrameAttributes2dPosY[ p ] >> 8)&0xFF
      stringByte[ posByte++ ] = AtlasFrameAttributes2dSizeX[ p ] & 0xFF
      stringByte[ posByte++] = (AtlasFrameAttributes2dSizeX[p] >> 8) &0xFF
      stringByte[ posByte++ ] = AtlasFrameAttributes2dSize Y[ p ] & 0xFF
      stringByte[ posByte++] = (AtlasFrameAttributes2dSizeY[p] >> 8) &0xFF
// ----------
      }
      return posbyte
    }
```

### 3.5. Tile Meshpatch Byte String

The Tile meshpatch byte string is formed from variables that are used by the tile to atlas frame conversion subclause (9.2.9). It is equivalent to the atlas meshpatch byte string function, only has an additional tile type at the beginning, as shown below:

```
  // -------- Tile Meshpatch Byte String
TileMeshpatchByteString( stringByte, posByte, tileID, p ) {
  stringByte[ posByte++ ] = TileMeshpatchType[ t ][ p ] & 0xFF
  stringByte[ posByte++ ] = ( TileMeshpatchType[ t ][ p ] >> 8 ) & 0xFF
  stringByte[ posByte++ ] = TileMeshpatchSubmeshID[ p ] & 0xFF
  if( TileMeshpatchType[ t ][ p ] == I_TILE ||
    TileMeshpatchType[ t ][ p ] == P_TILE ) {
  if( AspsDisplacementIdPresentFlag )
```

### 3.6. OrthoAtlas Subpatch Byte String

The orthoAtlas subpatch byte string is formed from variables that are used by the tile to atlas frame conversion subclause (9.2.9.2.2). Two functions are defined, one for atlas frame level and another for tile level, as shown below.

```
  // -------- AtlasSubpatchByteString --------
AtlasSubpatchByteString( stringByte, posByte, p ) {
  stringByte[ posByte++ ] = AtlasFrameNumSubpatches[ p ] & 0xFF
  stringByte[ posByte++] = (AtlasFrameNumSubpatches[ p ] >> 8) &0xFF
  for( i = 0; i < AtlasFrameNumSubpatches[ p ]; i++ ){
    stringByte[ posByte++]=AtlasFrameSubpatchIdxToFaceId[p][i] &0xFF
    stringByte[ posByte++ ] =
        (AtlasFrameSubpatchIdxToFaceId[ p ][ i ] >> 8 ) & 0xFF
    stringByte[ posByte++ ] = AtlasFrameNumRawCoords[ p ][ i ] & 0xFF
    stringByte[posByte++]=(AtlasFrameNumRawCoords[p][i]>>8) &0xFF
    if( AtlasFrameNumRawCoords[ p ][ i ] > 0 ) {
        for( n = 0; n < AtlasFrameNumRawCoords[ p ][ i ]; n++ ) {
          stringByte[ posByte++ ] =
            AtlasFrameRawUCoords[ p ][ i ][ n ] & 0xFF
          stringByte[ posByte++ ] =
            (AtlasFrameRawUCoords[ p ][ i ][ n ] >> 8 ) & 0xFF
          stringByte[ posByte++ ] =
            AtlasFrameRawVCoords[ p ][ i ][ n ] & 0xFF
          stringByte[ posByte++ ] =
            (AtlasFrameRawVCoords[ p ][ i ][ n ] >> 8 ) & 0xFF
      }
  } else {
        stringByte[ posByte++ ] =
            AtlasFrameSubpatchProjectionID[ p ][ i ] & 0xFF
        stringByte[ posByte++ ] =
            AtlasFrameSubpatchOrientationID[ p ][ i] & 0xFF
        stringByte[ posByte++ ] =
            AtlasFrameSubpatch2dPosX[ p ][ i ] & 0xFF
        stringByte[ posByte++ ] =
            ( AtlasFrameSubpatch2dPosX[ p ][ i ] >> 8 ) & 0xFF
        stringByte[ posByte++ ] =
            AtlasFrameSubpatch2dPosY[ p ][ i ] & 0xFF
        stringByte[ posByte++ ] =
            (AtlasFrameSubpatch2dPosY[ p ][ i ] >> 8 ) & 0xFF
        stringByte[ posByte++ ] =
            AtlasFrameSubpatch2dSizeX[ p ][ i ] & 0xFF
        stringByte[ posByte++ ] =
            (AtlasFrameSubpatch2dSizeX[ p ][ i ] >> 8 ) & 0xFF
        stringByte[ posByte++ ] =
            AtlasFrameSubpatch2dSizeY[ p ][ i ] & 0xFF
        stringByte[ posByte++ ] =
            (AtlasFrameSubpatch2dSizeY[ p ][ i ] >> 8 ) & 0xFF
        if(AspsProjectionTexcoordBboxBiasEnableFlag ){
          stringByte[ posByte++ ] =
            AtlasFrameSubpatch2dBiasX[ p ][ i ] & 0xFF
          stringByte[ posByte++ ] =
            (AtlasFrameSubpatch2dBiasX[ p ][ i ] >> 8 )& 0xFF
          stringByte[ posByte++ ] =
            AtlasFrameSubpatch2dBiasY[ p ][ i ] & 0xFF
          stringByte[ posByte++ ] =
            (AtlasFrameSubpatch2dBiasY[ p ][ i ] >> 8 ) & 0xFF
        }
        stringByte[ posByte++ ] =
            AtlasFrameSubpatchScale[ p ][ i ] & 0xFF
        stringByte[ posByte++ ] =
            (AtlasFrameSubpatchScale[ p ][ i ] >> 8 ) & 0xFF
        stringByte[ posByte++ ] =
            (AtlasFrameSubpatchScale[ p ][ i ] >> 16 ) & 0xFF
        stringByte[ posByte++ ] =
            (AtlasFrameSubpatchScale[ p ][ i ] >> 24 ) & 0xFF
        }
      }
      return posByte
  }
```

### 3.7. Tile Subpatch Byte String

```
    // -------- Tile Subpatch Byte String ----------
TileSubpatchByteString( stringByte, posByte, t, p ) {
    stringByte[ posByte++ ] = TileMeshpatchNumSubpatches[ t ][ p ]&0xFF
    stringByte[ posByte++] =
        (TileMeshpatchNumSubpatches[ t ][ p ] >> 8 ) & 0xFF
    for( i = 0; i < TileMeshpatchNumSubpatches[ t ][ p ]; i++ ){
      stringByte[ posByte++ ] =
        TileMeshpatchSubpatchIdxToFaceId[ t ][ p ][ i ] & 0xFF
      stringByte[ posByte++ ] =
        (TileMeshpatchSubpatchIdxToFaceId[ t ][ p ][ i ] >> 8 ) & 0xFF
      stringByte[ posByte++ ] =
        TileMeshpatchNumRawCoords[ t ][ p ][ i ] & 0xFF
      stringByte[ posByte++ ] =
        (TileMeshpatchNumRawCoords[ t ][ p ][ i ] >> 8 ) & 0xFF
      if(TileMeshpatchNumRawCoords[ t ][ p ][ i ] > 0 ) {
        for( n = 0; n < TileMeshpatchNumRawCoords[ t ][ p ][ i ]; n++ ) {
          stringByte[ posByte++ ] =
              TileMeshpatchRawUCoords[ t ][ p ][ i ][ n ] & 0xFF
          stringByte[ posByte++ ] =
              (TileMeshpatchRawUCoords[ t ][ p ][ i ][ n ] >> 8 )& 0xFF
          stringByte[ posByte++ ] =
              TileMeshpatchRawVCoords[ t ][ p ][ i ][ n ] & 0xFF
          stringByte[ posByte++ ] =
              (TileMeshpatchRawVCoords[ t ][ p ][ i ][ n ] >> 8 )& 0xFF
        }
      } else {
        stringByte[ posByte++ ] =
              TileMeshpatchSubpatchProjectionID[ t ][ p ][ i ] & 0xFF
        stringByte[ posByte++ ] =
              TileMeshpatchSubpatchOrientationID[ t ][ p ][ i] & 0xFF
        stringByte[ posByte++ ] =
              TileMeshpatchSubpatch2dPosX[ t ][ p ][ i ] & 0xFF
        stringByte[ posByte++ ] =
              (TileMeshpatchSubpatch2dPosX[ t ][ p ][ i ] >> 8 ) & 0xFF
        stringByte[ posByte++ ] =
              TileMeshpatchSubpatch2dPosY[ t ][ p ][ i ] & 0xFF
        stringByte[ posByte++ ] =
              (TileMeshpatchSubpatch2dPosY[ t ][ p ][ i ] >> 8 ) & OxFF
        stringByte[ posByte++ ] =
              TileMeshpatchSubpatch2dSizeX[ t ][ p ][ i ] & 0xFF
        stringByte[ posByte++ ] =
              (TileMeshpatchSubpatch2dSizeX[ t ][ p ][ i ] >> 8 ) & 0xFF
        stringByte[ posByte++ ] =
              TileMeshpatchSubpatch2dSizeY[ t ][ p ][ i ] & 0xFF
        stringByte[ posByte++ ] =
              (TileMeshpatchSubpatch2dSizeY[ t ][ p ][ i ] >> 8 ) & 0xFF
        if( AspsProjectionTexcoordBboxBiasEnableFlag ){
            stringByte[ posByte++ ] =
              TileMeshpatchSubpatch2dBiasX[ t ][ p ][ i ] & 0xFF
            stringByte[ posByte++ ] =
              (TileMeshpatchSubpatch2dBiasX[ t ][ p ][ i ] >> 8 )& 0xFF
            stringByte[ posByte++ ] =
              TileMeshpatchSubpatch2dBiasY[ t ][ p ][ i ] & 0xFF
            stringByte[ posByte++ ] =
              (TileMeshpatchSubpatch2dBiasY[ t ][ p ][ i ] >> 8 ) & 0xFF
        }
        stringByte[ posByte++ ] =
              TileMeshpatchSubpatchScale[ t ][ p ][ i ] & 0xFF
        stringByte[ posByte++ ] =
              (TileMeshpatchSubpatchScale[ t ][ p ][ i ] >> 8 ) & 0xFF
        stringByte[ posByte++ ] =
              (TileMeshpatchSubpatchScale[ t ][ p ][ i ] >> 16 ) & 0xFF
        stringByte[ posByte++ ] =
              (TileMeshpatchSubpatchScale[ t ][ p ][ i ] >> 24 ) & 0xFF
      }
    }
    return posByte
  }
```

### 4. GENERAL SCOPE OF EMBODIMENTS

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A method of extending the visual volumetric video-based coding (V3C) standard syntax for transmission of dynamic meshes, comprising: (a) modifying existing decoded atlas hash supplemental enhancement information (SEI) to use syntax elements and variables defined in the V3C extension used by the video-based dynamic mesh coding (V-DMC) specification; (b) creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and (c) wherein the extensions of the V3C syntax enable efficient encoding of dynamic meshes, including modification of a V3C level SEI message to calculate a hash using new syntax elements from the V-DMC specification.

A method of extending the visual volumetric video-based coding (V3C) standard syntax for transmission of dynamic meshes, performed as series of steps on a computer, comprising: (a) modifying existing decoded atlas hash supplemental enhancement information (SEI) to use syntax elements and variables defined in the V3C extension used by the video-based dynamic mesh coding (V-DMC) specification; (b) creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and (c) wherein the extensions of the V3C syntax enable efficient encoding of dynamic meshes, including modification of a V3C level SEI message to calculate a hash using new syntax elements from the V-DMC specification; and wherein the new byte strings as extensions to the V3C syntax use syntax elements that describe operations such as texture mapping and displacement images, while preserving existing V3C syntax.

An apparatus for extending the visual volumetric video-based coding (V3C) standard syntax for transmission of dynamic meshes, comprising: (a) a processor and a non-transitory memory storing instructions executable by the processor performing V3C coding, wherein said instructions, when executed by the processor, perform steps for coding V3C syntax, comprising: (a)(i) modifying existing decoded atlas hash supplemental enhancement information (SEI) to use syntax elements and variables defined in the V3C extension used by the video-based dynamic mesh coding (V-DMC) specification; (a)(ii) creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and (a)(iii) wherein the extensions of the V3C syntax enable efficient encoding of dynamic meshes, including modification of a V3C level SEI message to calculate a hash using new syntax elements from the V-DMC specification.

The apparatus or method of any preceding or following implementation, wherein the new byte strings as extensions to the V3C syntax use syntax elements that describe operations such as texture mapping and displacement images, while preserving existing V3C syntax.

The apparatus or method of any preceding or following implementation, wherein transmitting parameters for a basemesh bitstream, provides improved integration with existing V3C syntax elements which are utilized for other data types, including point cloud encoding.

The apparatus or method of any preceding or following implementation, wherein sub-patches are utilized to transmit texture parametrization information for the basemesh, and uses a flexible data arrangement in 2D and in 3D, with different mappings for a texture location in 2D and for the face mapping in 3D.

The apparatus or method of any preceding or following implementation, wherein the decoded atlas hash SEI message is utilized for conformance testing as the hash values are generated at encoder and decoder sides to determine bitstream mismatch testing.

The apparatus or method of any preceding or following implementation, wherein said apparatus comprises a computer operating to perform V3C encoding.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method of extending the visual volumetric video-based coding (V3C) standard syntax for transmission of dynamic meshes, comprising:
modifying existing decoded atlas hash supplemental enhancement information (SEI) to use syntax elements and variables defined in the V3C extension used by the video-based dynamic mesh coding (V-DMC) specification;
creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and
wherein the extensions of the V3C syntax enable efficient encoding of dynamic meshes, including modification of a V3C level SEI message to calculate a hash using new syntax elements from the V-DMC specification.

2. The method of claim 1, wherein the new byte strings as extensions to the V3C syntax use syntax elements that describe operations such as texture mapping and displacement images, while preserving existing V3C syntax.

3. The method of claim 1, wherein transmitting parameters for a basemesh bitstream, provides improved integration with existing V3C syntax elements which are utilized for other data types, including point cloud encoding.

4. The method of claim 3, wherein sub-patches are utilized to transmit texture parametrization information for the basemesh, and uses a flexible data arrangement in 2D and in 3D, with different mappings for a texture location in 2D and for the face mapping in 3D.

5. The method of claim 1, wherein the decoded atlas hash SEI message is utilized for conformance testing as the hash values are generated at encoder and decoder sides to determine bitstream mismatch testing.

6. A method of extending the visual volumetric video-based coding (V3C) standard syntax for transmission of dynamic meshes, performed as series of steps on a computer, comprising:
modifying existing decoded atlas hash supplemental enhancement information (SEI) to use syntax elements and variables defined in the V3C extension used by the video-based dynamic mesh coding (V-DMC) specification;
creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and
wherein the extensions of the V3C syntax enable efficient encoding of dynamic meshes, including modification of a V3C level SEI message to calculate a hash using new syntax elements from the V-DMC specification; and wherein the new byte strings as extensions to the V3C syntax use syntax elements that describe operations such as texture mapping and displacement images, while preserving existing V3C syntax.

7. The method of claim 6, wherein transmitting parameters for a basemesh bitstream, provides improved integration with existing V3C syntax elements which are utilized for other data types, including point cloud encoding.

8. The method of claim 7, wherein sub-patches are utilized to transmit texture parametrization information for the basemesh, and uses a flexible data arrangement in 2D and in 3D, with different mappings for a texture location in 2D and for the face mapping in 3D.

9. The method of claim 6, wherein the decoded atlas hash SEI message is utilized for conformance testing as the hash values are generated at encoder and decoder sides to determine bitstream mismatch testing.

10. An apparatus for extending the visual volumetric video-based coding (V3C) standard syntax for transmission of dynamic meshes, comprising:
a processor and a non-transitory memory storing instructions executable by the processor performing V3C coding, wherein said instructions, when executed by the processor, perform steps for coding V3C syntax, comprising:
modifying existing decoded atlas hash supplemental enhancement information (SEI) to use syntax elements and variables defined in the V3C extension used by the video-based dynamic mesh coding (V-DMC) specification;
creating new byte strings as extensions to the V3C syntax defining decoding process for dynamic meshes, based on variables and syntax elements defined by the extension mechanism of the V3C specification for the V-DMC specification, which are present in atlas frame parameter set (AFPS) VDMC extension, atlas sequence parameter set (ASPS) V-DMC extension, and also in newly defined mesh patches; and
wherein the extensions of the V3C syntax enable efficient encoding of dynamic meshes, including modification of a V3C level SEI message to calculate a hash using new syntax elements from the V-DMC specification.

11. The apparatus of claim 10, wherein the new byte strings as extensions to the V3C syntax use syntax elements that describe operations such as texture mapping and displacement images, while preserving existing V3C syntax.

12. The apparatus of claim 10, wherein transmitting parameters for a basemesh bitstream, provides improved integration with existing V3C syntax elements which are utilized for other data types, including point cloud encoding.

13. The apparatus of claim 12, wherein sub-patches are utilized to transmit texture parametrization information for the basemesh, and uses a flexible data arrangement in 2D and in 3D, with different mappings for a texture location in 2D and for the face mapping in 3D.

14. The apparatus of claim 10, wherein the decoded atlas hash SEI message is utilized for conformance testing as the hash values are generated at encoder and decoder sides to determine bitstream mismatch testing.

15. The apparatus of claim 10, wherein said apparatus comprises a computer operating to perform V3C encoding.
